(19) United States
(12) Patent Application Publication
(10) Pub. No.: US 2004/0037082 A1
(43) Pub. Date: Feb. 26, 2004

(54) Dimming apparatus

(76) Inventor: Finn Schmidt, Ugelbolle (DK)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/363,867

(22) PCT Filed: Sep. 10, 2001
(86) PCT No.: PCT/EP01/10436

(30) Foreign Application Priority Data
Sep. 8, 2000 (DK) DK 200001342

(51) Int. Cl. F21V 11/00

(52) U.S. Cl. 362/351

(57) ABSTRACT

In a mechanical light dimmer system of the type having opposed dimmer plates to be moved laterally into the light beam of a projector the edges of the dimmer plates are connected with shortly projecting diffuser plates, such that these will be fully operative only when the dimmer plates are almost closed. It has been found that it is thus possible to ensure an evenly illuminated light spot also in the maximum dimming range, without generally reducing the lighting capacity of the projector.

### FIELD OF THE INVENTION

The present invention relates to a dimmer system for a light projector, i.e. a system for adjusting the amount of light present in the light emission from the projector.

### BACKGROUND

In many circumstances, such as in theatre lighting, it is important to ensure that the light intensity of a given light spot on a surface can be varied between a projector determined maximum and zero. While this could be achievable by an adjustment of the light emission from the projector bulb itself, it is nevertheless preferred to make use of adjustable dimmer plate systems operable to gradually shade off the light transmission from the bulb, particularly because relevant modern discharge bulbs are not suited for full radiation adjustment.

Moving dimmer plates into the light beam at a position spaced from the focal point of the projector generally does not alter the size of the light spot, but only alters the light intensity thereof. However, in order for the light spot to remain stable and evenly illuminated, it is a condition that the dimming is effected in a symmetrical manner about the middle axis of the light beam, not necessarily in accordance with the iris principle, but preferably from opposite sides of the light beam. This has lead to several different working principles including opposed “closable doors,” opposed displaceable finger plates, or rotary dimmer plates with circularly-arranged wedge-shaped slots.

In connection with the invention it has been observed that as the dimming proceeds towards a low light intensity in the light spot there appears a certain, visible distortion of the light, giving rise to unevenness of the light distribution in the light spot. It is believed that this is due to extremely small inaccuracies in the sharpness of the edges of the dimmer plates or perhaps due to previously described circumstances around light passage over sharp corners or, respectively, due to irregularities in the light source itself or other optical inaccuracies.

### SUMMARY OF THE INVENTION

The invention overcomes this problem by the provision of light diffuser means arranged in direct or indirect association with the edges of the dimmer plate system, extending somewhat beyond the relevant light cutting edges of the dimmer plates to cause the light distribution just next to these edges to be diffused at least in the lower adjustment range of the light intensity. The above described problem does not occur if the light, generally, is emitted through a diffuser filter, but any such filter will inevitably cause some reduction of the maximum brightness of the light spot and is, therefore, undesirable in practice. A similar, though reduced attenuation, of course, will arise from the introduction of the diffuser plates next to the light cutting edges of the dimmer system, however this no longer affects the maximum light intensity, and it has been found that the introduction of the free edge of a diffuser plate into the light beam does not give rise to any noticeable distortion of the light distribution in the light spots.

In one embodiment, the invention provides a projector with a mechanical light dimmer system including a light blocking plate element arranged in a cross movable manner relative to the light beam of the projector so as to exhibit light beam cutting edge portions gradually adjustable between an open position, in which the light beam is fully or widely non-dimmed, an almost closed position, in which the light beam is widely dimmed, and a closed position, in which the light beam is entirely blocked. The light dimmer system is also provided with diffuser elements which are operable so as to be generally held outside of the light beam as long as this beam is widely non-dimmed, while in the dimming area next to said almost closed position, said diffuser element means will be partially intruding into the light beam, while further towards said fully closed position the diffuser element means will be present throughout the entire cross section of the effective light beam.

In another embodiment, a diffuser element may be mounted so as to cover only the pointed end of a generally V-shaped recess in a light dimmer plate.

In yet another embodiment, the light blocking plate element is mounted so as to be pivotable into the light beam about an axis intersecting the light beam. In connection with the associated light beam edge cutting portions there may be rigidly fixed a diffuser in such a geometrical position such that the diffuser, during pivoting of the light blocking plate element into the light beam, is initially shadowed behind said light beam cutting edge portion, while in the course of pivoting into said fully closed position the diffuser element is swung progressively into the light beam for full coverage thereof during the final phase of the pivoting of the light blocking plate portion into its fully closed position.

In this embodiment, the diffuser element or elements preferably exhibit substantially the same diffuser effect all over their active area. In one embodiment, the diffuser plate is of frosted glass, prepared so as to be practically non-distorting adjacent their free edges and gradually more distorting towards their transition to the light cutting edge of the dimmer system. However, in practice, this configuration is not required for achieving a fully acceptable result. The diffuser plates may be of any usable type, whether with moulded or worked out surface irregularities of a transparent plate or with a printed spot pattern of light shading spots on one or both sides of a transparent plate. Even a spot or surface printing with graduated light penetration characteristics could be considered.

### BRIEF DESCRIPTION OF THE DRAWINGS

In the following the invention is described in more detail with reference to the drawings, in which:

FIG. 1 is a perspective view illustrating the principle of the invention;

FIG. 2 is an elevation of an almost closed dimmer unit;

FIG. 3 is a sectional view of a practical embodiment of the invention;

FIG. 4 a perspective view of a part of the embodiment of FIG. 3;

FIG. 5 as an elevation of a modified traditional dimmer plate;

FIG. 6 is a perspective view of a development of the embodiment of FIG. 3;

FIG. 7 is a reverse perspective view of the embodiment of FIG. 6;

FIG. 8 is an elevation of the embodiment of FIG. 6; and

FIG. 9 is a plan view of the embodiment of FIG. 6 in the position of FIG. 8.

### DETAILED DESCRIPTION

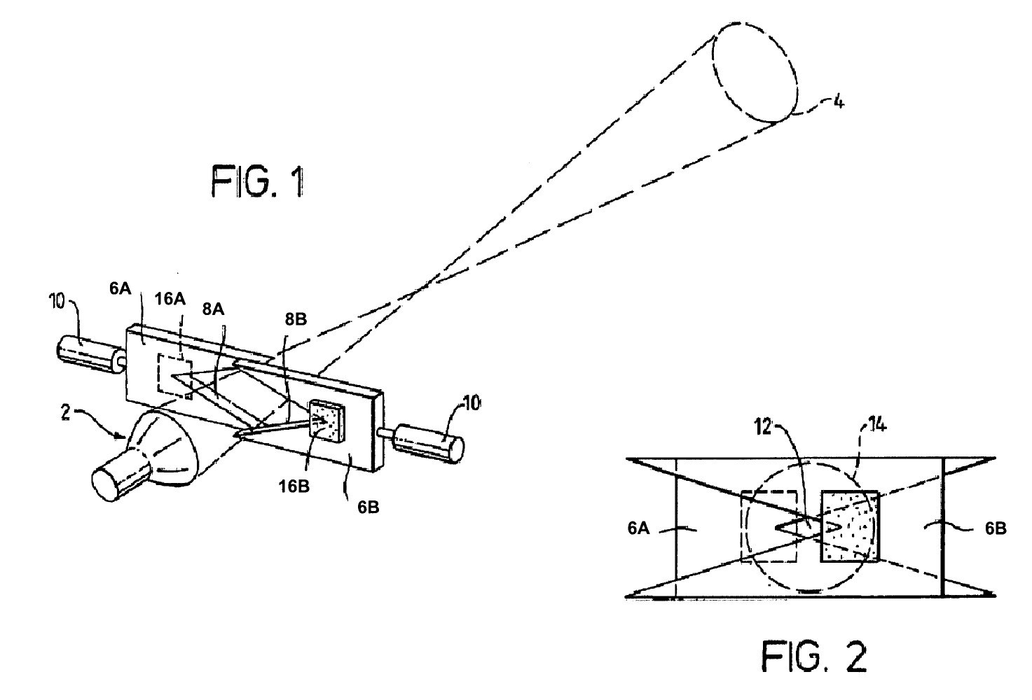

In FIG. 1 is shown a reflector lamp 2 forming a light spot 4 on any relevant surface. In front of the lamp 2 there is arranged a pair of dimmer plates 6A, 6B, each having an inwardly open V-shapes incision 8A, 8B and each connected to movement control element 10 operable to displace the plates towards and away from each other, sliding across each other. It is easily understood that the V-shaped incisions 8A, 8B can be controlled thus to effect any degree of attenuation of the light beam from the lamp 2, from a full illumination down to a complete darkening of the beam. The light spot 4 will maintain its diameter, but its light intensity will decrease towards zero as the dimmer plates 6 are displaced inwardly.

FIG. 2 shows a situation in which there remains only a small diamond-shaped 12 between the plates before a complete shutting off (or after an initial opening from a shut-off position) of the plates 6. The relevant light beam is represented by a circle 14.

According to the invention, the minimum width portions of the V-shaped incisions 8A, 8B are filled out or covered by a semi-opaque, translucent, plate member 16A, 16B of “frosted” type, i.e., having irregularities resulting in a more or less pronounced diffusion of the light penetrating the translucent plates. In the fully open position of the dimmer plates, shown in FIG. 1, these semi-opaque members 16A, 16B are located entirely outside of the light beam, i.e., they do not give rise to any kind of attenuation of the light intensity of the light spot 4.

As the dimmer system is closed (FIG. 2), the frosted members 16A, 16B gradually fill out an increasingly larger percentage of the diamond-shaped opening 12 until the opening is completely closed. As mentioned above, this will result in an even light distribution of the light spot 4, even in the lowermost range of the adjustment interval, just prior to final shutting-off or just after activation of the light beam.

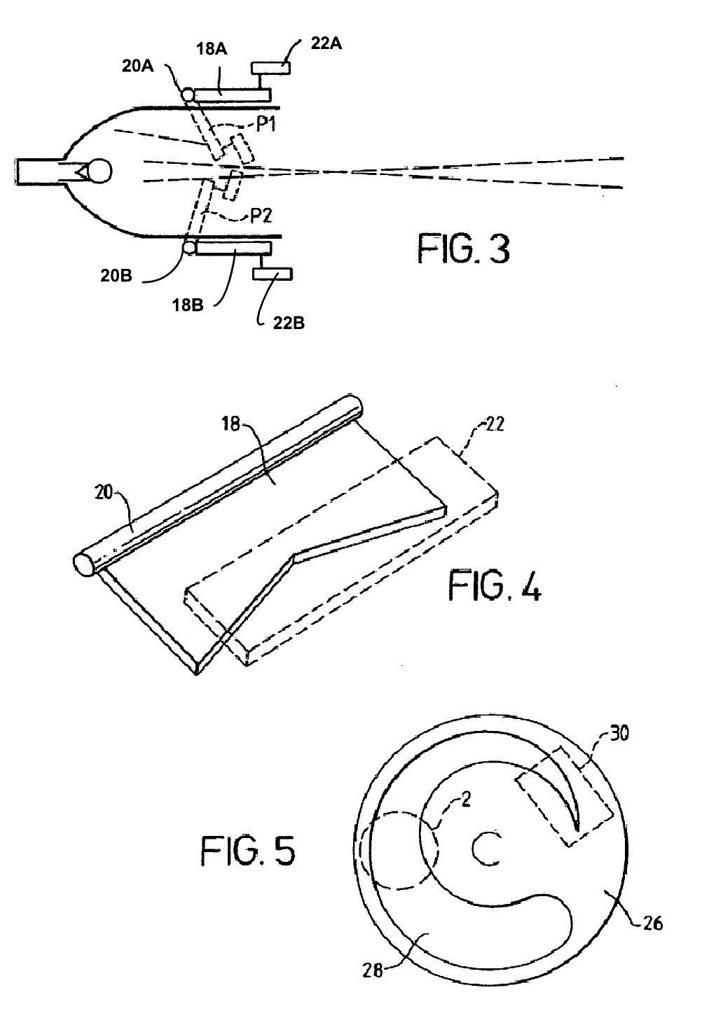

FIGS. 3 and 4 show another embodiment, where the entire dimmer system is only as wide as the reflector lamp 2 itself. The system comprises two opposed dimmer plates 18A, 18B each arranged so as to pivot about an exterior edge axis 20A, 20B, whereby they can be swung together from a fully open position, as shown in full lines, towards a fully closed position in front of the reflector lamp 2. Adjacent and outside its edge, each plate 18A, 18B is coupled to a semi-opaque plate member 22A, 22B slightly spaced from the plate interior and slightly projecting beyond the outer edge thereof.

During the initial and middle part of their closing movement, the dimmer plates 18A, 18B shadow each corresponding frosted plates 22 until the position P1, shown in dotted lines, is reached. After this stage, as illustrated by position P2, the frosted plates 22 will be brought increasingly into the light beam, which is still emitted between the edges of the dimmer plates. Finally the light beam, now in its entirety, passes through the frosted plates 22, and is cut off when the dimmer plates are brought fully together, preferably with some overlapping at the outer edges.

In connection with such a final overlapping, the dimmer plates 18A, 18B are preferably slightly V-shaped around their internal edges, as illustrated in FIG. 4. This shaping ensures that the final attenuation of the light beam to zero is controlled in a gradual and well defined manner.

FIG. 5 shows a well-known type of an adjustable dimmer plate arranged as a rotary plate 26, provided with an arched (arcuate), wedge-shaped recess 28. The plate is placed in front of the light source 2 with the latter located slightly laterally offset from the center of the plate, or disc 26. It is readily understood that the dimming of the light will be adjustable between “fully open” and “fully closed,” according to the angular setting of the wedge recess 28 relative to the lamp 2. In this respect, it is very easy to implement the principle of the invention, by adding a diffuser element 30 to cover the narrow end of the recess. However, this solution will still require a wide mounting space on the side of the light source 2.

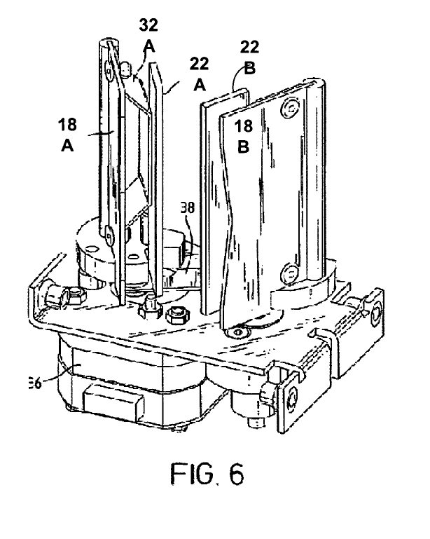

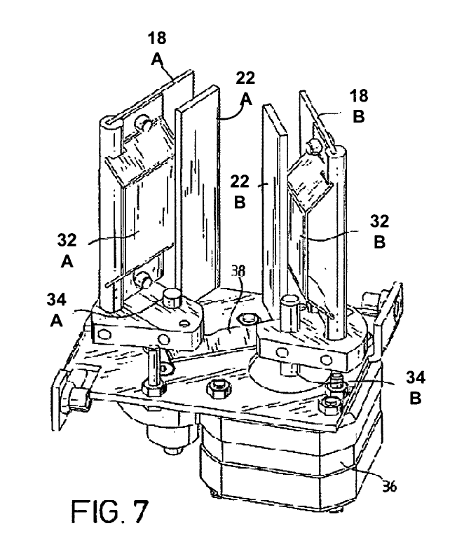

FIGS. 6, 7, 8, and 9 show a further embodiment of the invention, which is a development of the embodiment of FIG. 3. In this embodiment, the diffusers 22A, 22B are each mounted on a respective spacer member 32A, 32B which is attached to a respective shutter plate 18A, 18B. The shutters 18A, 18B are rotatable about respective pivots 34A, 34B under the control of an electric motor 36. The pivots 34A, 34B are spaced from the plane of the respective shutter 18. The electric motor 36 drives a first shutter 18A directly. The rotational movement is transmitted to a second shutter 18B via a transmission member 38 which is pivotally connected at each end to the base of each shutter.

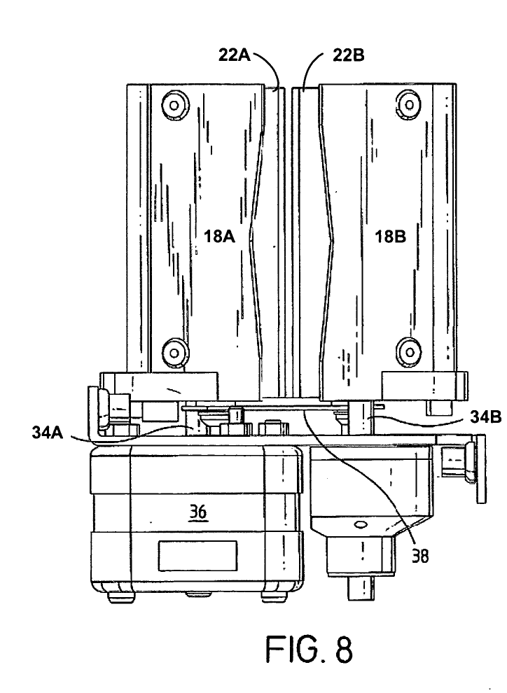

The diffusers 22 are mounted relative to the shutters 18 such that as the shutters 18 rotate about the pivots 34, the diffusers 22 diffuse light at the edges of the light path, which is defined by the gap between the shutters 18. In this way, as shown in FIG. 8, when the space between the shutters 18A, 18B is relatively small, for high attenuation of the beam, the diffusers 22A, 22B diffuse substantially all light passing between the shutters 18 to provide an even illumination.

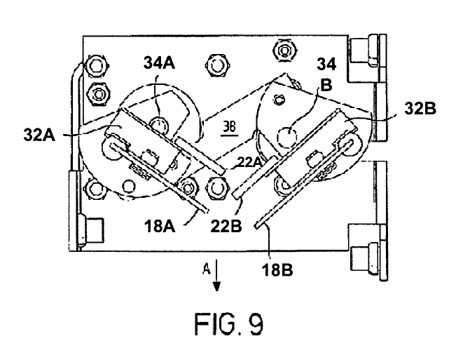

The spacing of the diffusers 22A, 22B from the shutters 18A, 18B in the direction of the light beam (indicated by arrow A in FIG. 9) provides a more homogeneous diffusion effect when the light beam is converging towards the space between the shutters.

Viewed from a further aspect, the invention provides a dimming apparatus for a luminaire comprising at least one shutter which is movable, in use, to dim a light beam by restricting the cross-sectional area of the beam and at least one diffuser which is arranged to diffuse light in a perimeter region of the cross-section of the light beam adjacent the shutter, wherein the perimeter region is smaller than the cross-sectional area of the un-attenuated light beam, and the diffuser is spaced from the shutter in the direction of the light beam.

The diffuser may be arranged for movement with the shutter. In particular, the diffuser may be connected or mounted to the shutter. The shutter and/or the diffuser may be arranged to rotate about a pivot. The pivot may be common to the shutter and diffuser.

The dimming apparatus may comprise a spacer member arranged to maintain the diffuser and shutter in spaced relation. In this embodiment, the spacing between the diffuser and the shutter may be greater than 1 mm, greater than 2 mm, greater than 3 mm, greater than 4 mm or even greater than 5 mm.

The invention extends to a luminaire comprising a light source and dimming apparatus according to the invention. The diffuser may be spaced towards the light source relative to the shutter.

A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A mechanical light dimmer for a projector having a light beam emanating from a light source along a beam path, the dimmer system comprising:
a light blocking plate arranged in a cross movable manner relative to the light beam path so as to controllably introduce light beam cutting edge portions across the light path, between an open position, in which the light beam is substantially non-dimmed, an almost closed position, in which the light beam is widely dimmed, and a closed position, in which the light beam is entirely blocked;
a diffuser element which is adaptable to be generally positioned outside of the light beam path as long as the light beam is widely non-dimmed, to be partially intruding into the light beam while the light beam is in said almost closed position, to be present throughout the entire cross section of the effective light beam while the light beam is further towards said fully closed position.

2. A light dimmer according to claim 1, in which a diffuser element is mounted so as to cover only the pointed end of a generally V-shaped opening in said light blocking plate.

3. A light dimmer according to claim 1, in which the light blocking plate means are mounted so as to be pivotable into the light beam about an axis intersecting the light beam, whereas in connection with the associated light beam edge cutting portions there is rigidly fixed a diffuser element in such a geometrical position that this element, during pivoting of the light blocking plate means into the light beam, is initially shadowed behind said light beam cutting edge portion, while in the course of pivoting into said fully closed position the diffuser element is swung progressively into the light beam for full coverage thereof during the final phase of the pivoting of the light blocking plate portion into its fully closed position.

4. A light dimmer according to claim 1, in which the diffuser element means exhibit substantially the same diffuser effect all over its active area.

5. Dimming apparatus for a luminaire, comprising:
at least one shutter which is movable, in use, to dim a light beam by restricting the cross-sectional area of the beam; and
at least one diffuser which is arranged to diffuse light in a perimeter region of the cross-section of the light beam adjacent the shutter, wherein the perimeter region is smaller than a cross-sectional area of the un-attenuated light beam, and
the diffuser is spaced from the shutter in the direction of a center axis of the light beam.

6. Dimming apparatus as in claim 5, wherein the diffuser is mounted on the shutter.

7. Dimming apparatus as in claim 6, further comprising a spacer member arranged to maintain the diffuser and shutter in a spaced relation.

8. A dimming plate in a light dimming apparatus, comprising:
an opaque planer portion, the planer portion including a tapered opening extending from a wide maximum end to a narrow minimum end; and
a semi-opaque diffuser plate extending from the periphery of said tapered opening to cover at least opening portions around said narrow minimum end.

9. The dimming plate of claim 8, wherein said semi-opaque diffuser plate is a frosted glass plate.

10. A method for dimming a light beam emanating along a beam path, comprising:
attenuating the light beam by introducing an opaque element into the beam path, starting with exterior portions of a cross-sectional area of the beam; and
further attenuating the light beam, after predetermined attenuation of the light beam by said opaque element, by introducing a semi-opaque screen into the light path of the beam, the semi-opaque screen affecting portions of the light beam which are further inside the cross-sectional area of the beam from portions affected by said attenuating by said opaque element.
